(19) United States
(12) Patent Application Publication
(10) Pub. No.: US 2026/0296950 A1
(43) Pub. Date: Oct. 1, 2026

(54) OPTICAL GLASS, GLASS PREFORM, OPTICAL ELEMENT AND OPTICAL INSTRUMENT

(71) Applicant: CDGM GLASS CO., LTD, Chengdu (CN)

(72) Inventor: Bo KUANG, Chengdu (CN)

(21) Appl. No.: 19/698,666

(22) Filed: Jun. 4, 2026

Related U.S. Application Data
(63) Continuation of application No. 18/231,424, filed on Aug. 8, 2023, now Pat. No. 12,679,758.

(30) Foreign Application Priority Data
Aug. 26, 2022 (CN) 202211031087.X

(51) Int. Cl. C03C 3/068; G02B 1/00

(52) U.S. Cl. CPC C03C 3/068; G02B 1/00

(57) ABSTRACT

The application provides an optical glass, wherein components thereof are represented by weight percentage, comprising: 1-15% of SiO₂; 5-20% of B₂O₃; 25-50% of La₂O₃; 1-12% of ZrO₂; 5-20% of TiO₂; 10-35% of RO, and the RO is total content of MgO, CaO, SrO, and BaO.

### CROSS-REFERENCE TO RELATED APPLICATIONS

This application is a continuation application of U.S. patent application Ser. No. 18/231,424, filed on Aug. 8, 2023, which claims priority to Chinese patent application No. 202211031087X, filed on Aug. 26, 2022. The contents of the above identified applications are hereby incorporated herein in their entireties by reference.

### TECHNICAL FIELD

The present invention relates to an optical glass, in particular to an optical glass having a refractive index of 1.87-1.93 and an Abbe number of 28-35, as well as a glass preform made of the optical glass, an optical element and an optical instrument.

### BACKGROUND

In recent years, with the rapid development of photoelectric information, digital display, monitoring security, vehicle imaging and other fields, the optical element applied to optical system is required to be miniature and lightweight with high performance. High-refractivity and high-dispersion optical glass can be coupled with low-dispersion optical glass, thereby effectively eliminating chromatic aberration and secondary spectrum. At the same time, it can effectively shorten the total optical length of the lens and miniaturize the imaging system. Therefore, this type of glass has extensive application prospects. Under the same curvature radius, the glass with higher refractive index can obtain a larger imaging field of view, which is conducive to reducing the number of optical elements in the optical instrument. With the development trend of miniaturization of optical instruments, the trend of demand for glass with high refractive index is becoming more and more obvious. In addition to reducing the number of optical elements in the optical system, reducing the density of the optical glass is also an important way to achieve the purpose of lightweight optical instruments.

### SUMMARY

A technical problem to be solved by the present invention is to provide an optical glass with low density and high refractive index.

To solve the technical problem, the technical scheme of the present invention provides:

An optical glass, wherein components thereof are represented by weight percentage, comprising: 1-15% of SiO₂; 5-20% of B₂O₃; 25-50% of La₂O₃; 1-12% of ZrO₂; 5-20% of TiO₂; 6-35% of RO, wherein the RO is total content of MgO, CaO, SrO, and BaO.

Furthermore, the optical glass, wherein components thereof are represented by weight percentage, further comprising: 0-8% of Y₂O₃; and/or 0-8% of Gd₂O₃; and/or 0-5% of Yb₂O₃; and/or 0-12% of Nb₂O₅; and/or 0-10% of ZnO; and/or 0-8% of Rn₂O; and/or 0-5% of GeO₂; and/or 0-5% of WO₃; and/or 0-5% of Ta₂O₅; and/or 0-5% of Al₂O₃; and/or 0-1% of clarifying agent, the Rn₂O is one or more of Li₂O, Na₂O, and K₂O, and the clarifying agent is one or more of Sb₂O₃, SnO, SnO₂, and CeO₂.

An optical glass, wherein components thereof are represented by weight percentage, consisting of: 1-15% of SiO₂; 5-20% of B₂O₃; 25-50% of La₂O₃; 1-12% of ZrO₂; 5-20% of TiO₂; 6-35% of RO; 0-8% of Y₂O₃; 0-8% of Gd₂O₃; 0-5% of Yb₂O₃; 0-12% of Nb₂O₅; 0-10% of ZnO; 0-8% of Rn₂O; 0-5% of GeO₂; 0-5% of WO₃; 0-5% of Ta₂O₅; 0-5% of Al₂O₃; and 0-1% of clarifying agent, the RO is total content of MgO, CaO, SrO, and BaO, Rn₂O is one or more of Li₂O, Na₂O, and K₂O, and the clarifying agent is one or more of Sb₂O₃, SnO, SnO₂, and CeO₂.

Furthermore, the optical glass, wherein components thereof are represented by weight percentage, in which: CaO/(SiO₂+ZrO₂) is 0.02-1.0, preferably CaO/(SiO₂+ZrO₂) is 0.05-0.8, more preferably CaO/(SiO₂+ZrO₂) is 0.1-0.6, further preferably CaO/(SiO₂+ZrO₂) is 0.1-0.5.

Furthermore, the optical glass, wherein components thereof are represented by weight percentage, in which: TiO₂/BaO is 0.3-3.0, preferably TiO₂/BaO is 0.4-2.0, more preferably TiO₂/BaO is 0.6-1.5, further preferably TiO₂/BaO is 0.8-1.3.

Furthermore, the optical glass, wherein components thereof are represented by weight percentage, in which: TiO₂/(La₂O₃+ZnO) is 0.1-0.6, preferably TiO₂/(La₂O₃+ZnO) is 0.15-0.55, more preferably TiO₂/(La₂O₃+ZnO) is 0.2-0.5, further preferably TiO₂/(La₂O₃+ZnO) is 0.25-0.45.

Furthermore, the optical glass, wherein components thereof are represented by weight percentage, in which: SiO₂/(CaO+BaO) is 0.05-1.5, preferably SiO₂/(CaO+BaO) is 0.1-1.0, more preferably SiO₂/(CaO+BaO) is 0.2-0.85, further preferably SiO₂/(CaO+BaO) is 0.35-0.75.

Furthermore, the optical glass, wherein components thereof are represented by weight percentage, in which: BaO/Nb₂O₅ is above 0.8, preferably BaO/Nb₂O₅ is 1.0-20.0, more preferably BaO/Nb₂O₅ is 1.5-10.0, further preferably BaO/Nb₂O₅ is 2.0-5.0.

Furthermore, the optical glass, wherein components thereof are represented by weight percentage, in which: (CaO+ZnO)/BaO is 0.1-3.0, preferably (CaO+ZnO)/BaO is 0.2-2.0, more preferably (CaO+ZnO)/BaO is 0.3-1.0, further preferably (CaO+ZnO)/BaO is 0.3-0.8.

Furthermore, the optical glass, wherein components thereof are represented by weight percentage, in which: La₂O₃/(ZnO+Nb₂O₅) is 2.0-15.0, preferably La₂O₃/(ZnO+Nb₂O₅) is 2.5-10.0, more preferably La₂O₃/(ZnO+Nb₂O₅) is 3.0-8.0, further preferably La₂O₃/(ZnO+Nb₂O₅) is 3.5-6.0.

Furthermore, the optical glass, wherein components thereof are represented by weight percentage, in which: (ZnO+Gd₂O₃+Y₂O₃)/CaO is below 5.0, preferably (ZnO+Gd₂O₃+Y₂O₃)/CaO is below 4.0, more preferably (ZnO+Gd₂O₃+Y₂O₃)/CaO is 0.2-3.0, further preferably (ZnO+Gd₂O₃+Y₂O₃)/CaO is 0.5-2.0.

Furthermore, the optical glass, wherein components thereof are represented by weight percentage, in which: SiO₂ is 3-12%, preferably SiO₂ is 5-10%; and/or B₂O₃ is 8-17%, preferably B₂O₃ is 10-15%; and/or La₂O₃ is 31-45%, preferably La₂O₃ is 34-40%; and/or ZrO₂ is 2-10%, preferably ZrO₂ is 3-8%; and/or TiO₂ is 8-18%, preferably TiO₂ is 11-16%; and/or RO is 10-25%, preferably RO is 11-20%; and/or Y₂O₃ is 0-4%, preferably Y₂O₃ is 0-2%; and/or Gd₂O₃ is 0-4%, preferably Gd₂O₃ is 0-2%; and/or Yb₂O₃ is 0-3%, preferably Yb₂O₃ is 0-1%; and/or Nb₂O₅ is 1-10%, preferably Nb₂O₅ is 2-7%; and/or ZnO is 1-8%, preferably ZnO is 2-7%; and/or Rn₂O is 0-4%, preferably Rn₂O is 0-2%; and/or GeO₂ is 0-3%, preferably GeO₂ is 0-1%; and/or WO₃ is 0-3%, preferably WO₃ is 0-1%; and/or Ta₂O₅ is 0-3%, preferably Ta₂O₅ is 0-1%; and/or Al₂O₃ is 0-3%, preferably Al₂O₃ is 0-1%; and/or clarifying agent is 0-0.5%, preferably clarifying agent is 0-0.2%, the RO is total content of MgO, CaO, SrO, and BaO, Rn₂O is one or more of Li₂O, Na₂O, and K₂O, and the clarifying agent is one or more of Sb₂O₃, SnO, SnO₂, and CeO₂.

Furthermore, the optical glass, wherein components thereof are represented by weight percentage, in which: BaO is 5-20%, preferably BaO is 8-18%, more preferably BaO is 11-16%; and/or SrO is 0-10%, preferably SrO is 0-5%, more preferably SrO is 0-2%; and/or CaO is 0-12%, preferably CaO is 1-10%, more preferably CaO is 2-8%; and/or MgO is 0-10%, preferably MgO is 0-5%, more preferably MgO is 0-2%.

Furthermore, the optical glass, wherein components thereof do not contain WO₃; and/or do not contain Ta₂O₅; and/or do not contain Rn₂O; and/or do not contain Al₂O₃; and/or do not contain GeO₂; and/or do not contain Y₂O₃; and/or do not contain Gd₂O₃; and/or do not contain SrO; and/or do not contain MgO; and/or do not contain Yb₂O₃, and the Rn₂O is one or more of Li₂, Na₂O, and K₂O.

Furthermore, a refractive index n_{d} of the optical glass is 1.87-1.93, preferably 1.88-1.92, more preferably 1.89-1.91, and an Abbe number v_{d} is 28-35, preferably 29-34, more preferably 30-33.

Furthermore, a thermal expansion coefficient α_{-30/70° C.} of the optical glass is below 95×10⁻⁷/K, preferably below 90×10⁻⁷/K, more preferably below 85×10⁻⁷/K, further preferably below 80×10⁻⁷/K; and/or water resistance stability D_{W} is above Class 2, preferably Class 1; and/or λ₇₀ is below 420 nm, preferably below 415 nm, more preferably below 410 nm; and/or λ₅ is below 380 nm, preferably below 375 nm, more preferably below 370 nm; and/or weather resistance CR is above Class 2, preferably Class 1; and/or Knoop hardness H_{K} is above 580×10⁷ Pa, preferably above 590×10⁷ Pa, more preferably above 600×10⁷ Pa, further preferably above 605×10⁷ Pa; and/or Young's modulus E is above 10000×10⁷ Pa, preferably above 10500×10⁷ Pa, more preferably above 11000×10⁷ Pa; and/or bubble degree is above Grade A, preferably above Grade A₀, more preferably Grade A₀₀; and/or density ρ is below 4.90 g/cm³, preferably below 4.80 g/cm³, more preferably below 4.70 g/cm³, further preferably below 4.60 g/cm³; and/or abrasion degree F_{A} is 125-165, preferably 130-160, more preferably 135-155; and/or transition temperature T_{g} is below 700° C., preferably below 690° C., more preferably below 680° C., further preferably below 678° C.

A glass preform is made of the above-mentioned optical glass.

An optical element, made of the above-mentioned optical glass or made of the above-mentioned glass preform.

An optical instrument, comprising the above-mentioned optical glass, and/or comprising the above-mentioned optical element.

The beneficial effects of the present invention are as follows: through rational component design, the optical glass of the present invention has low density while having the desired refractive index and Abbe number, which meets the lightweight application of optical instruments.

### DETAILED DESCRIPTION

The implementations of the optical glass provided by the present invention will be described in detail below, but the present invention is not limited to the following implementations. Appropriate changes may be made within the scope of the purpose of the present invention for implementation. In addition, the repeated descriptions will not limit the aim of the invention although with appropriate omissions. In the following, the optical glass of the present invention is sometimes referred to as glass.

### <Optical Glass>

Hereinafter, the components (ingredients) of the optical glass provided by the present invention will be described. If not specified herein, the content of each component and the total content are expressed in weight percentage (wt %), that is, the content of each component and the total content are expressed in weight percentage relative to the total glass materials converted into oxide composition. “Converted into oxide composition” therein refers to that the total weight of this oxide is taken as 100% when the oxide, compound salt and hydroxide, used as raw materials for the composition of the optical glass of the present invention, are decomposed and transformed into oxides during melting.

Unless otherwise noted in specific circumstances, the numerical range listed herein includes upper and lower limits, and the words “above” and “below” include the endpoint values as well as all integers and fractions within the range, but not limited to the specific values listed when the range is limited. “And/or” mentioned herein is inclusive. For example, “A and/or B” refers to only A, or only B, or both A and B.

### <Necessary Components and Optional Components>

SiO₂ has the effect of adjusting the optical constant, improving the chemical stability of the glass, maintaining the viscosity suitable for molten glass, reducing the abrasion degree, and reducing the erosion of refractory materials. The present invention comprises more than 1% of SiO₂ to obtain the above effect, and the content of SiO₂ is preferably more than 3%, more preferably more than 5%. If the content of SiO₂ is too high, the melting difficulty of the glass will increase, and the transition temperature will rise. Therefore, in the present invention, the upper limit of the SiO₂ content is 15%, preferably 12%, more preferably 10%.

B₂O₃ can increase the melting performance and devitrification resistance of the glass, and is conductive to reducing the transition temperature of the glass. The present invention comprises more than 5% of B₂O₃ to obtain the above effect, and the content of B₂O₃ is preferably more than 8%, more preferably more than 10%. If the content of B₂O₃ is too high, the chemical stability of the glass will deteriorate, especially the water resistance will deteriorate, and the refractive index and light transmittance of the glass will be decreased. Thus, the content of B₂O₃ is below 20%, preferably below 17%, more preferably below 15%.

As an effective ingredient for increasing the refractive index of the glass, La₂O₃ can significantly improve the chemical stability and devitrification resistance of the glass, but the required optical constant is difficult to be achieved when the content of La₂O₃ is lower than 25%; when the content of La₂O₃ is higher than 50%, the devitrification of the glass is liable to be increased, and the thermal stability will deteriorate. Therefore, the content of La₂O₃ is confined to 25-50%, preferably 31-45%, more preferably 34-40%.

Y₂O₃ can increase the refractive index and devitrification resistance of the glass. If the content of Y₂O₃ exceeds 8%, the chemical stability and weather resistance of the glass will deteriorate. Therefore, the content of Y₂O₃ is 0-8%, preferably 0-4%, more preferably 0-2%. In some implementations, it further preferably contains no Y₂O₃.

Gd₂O₃ can increase the refractive index and chemical stability of the glass. However, if the content of Gd₂O₃ exceeds 8%, the devitrification resistance and abrasion degree of the glass will deteriorate. Therefore, the content of Gd₂O₃ is 0-8%, preferably 0-4%, more preferably 0-2%. In some implementations, it further preferably contains no Gd₂O₃.

Yb₂O₃ is also a component which imparts high refractivity and low dispersion performance. If the content of Yb₂O₃ exceeds 5%, the anti-devitrification performance of the glass will be decreased. Therefore, the content of Yb₂O₃ is 0-5%, preferably 0-3%, more preferably 0-1%, it further preferably contains no Yb₂O₃.

ZrO₂ can increase the viscosity, hardness, refractive index and chemical stability of the optical glass and also lower the thermal expansion coefficient of the glass; when the content of ZrO₂ is too high, the devitrification resistance of the glass is reduced, the melting difficulty is increased, the melting temperature is increased, and the inclusion in the glass and the light transmittance are decreased. Therefore, the content of ZrO₂ is 1-12%, preferably 2-10%, more preferably 3-8%.

MgO can effectively reduce the relative partial dispersion of the glass. However, in case of excessive MgO content, the refractive index of the glass is difficult to meet the design requirements, and the anti-devitrification performance and stability of the glass will decrease. Therefore, the content of MgO is confined to 0-10%, preferably 0-5%, more preferably 0-2%. In some implementations, it further preferably contains no MgO.

CaO can adjust the optical constant of the glass, increase the chemical stability of the glass, improve the processing performance of the glass, reduce the high-temperature viscosity and surface tension of the glass, and reduce the difficulty of glass production. If the content of CaO is too high, the devitrification resistance of the glass will be reduced. Therefore, the content of CaO is 0-12%, preferably 1-10%, more preferably 2-8%.

In some implementations, the ratio of the content of CaO to the total content of SiO₂ and ZrO₂ (SiO₂+ZrO₂), i.e., CaO/(SiO₂+ZrO₂) is controlled to be within a range of 0.02-1.0, which can optimize the abrasion degree of the glass and prevent the hardness of the glass from deterioration. Therefore, CaO/(SiO₂+ZrO₂) is preferably 0.02-1.0, CaO/(SiO₂+ZrO₂) is more preferably 0.05-0.8. Furthermore, CaO/(SiO₂+ZrO₂) is controlled to be within a range of 0.1-0.6, which can also further reduce the density of the glass and optimize the weather resistance of the glass. Therefore, CaO/(SiO₂+ZrO₂) is further preferably 0.1-0.6, CaO/(SiO₂+ZrO₂) is more further preferably 0.1-0.5.

SrO can adjust the refractive index and Abbe number in the glass. However, if the content of SrO is too high, the chemical stability and devitrification resistance of the glass will be decreased. Therefore, the content of SrO is confined to 0-10%, preferably 0-5%, more preferably 0-2%. In some implementations, it further preferably contains no SrO.

BaO can increase the refractive index, melting performance and thermal stability of the glass, and improve the abrasion degree and light transmittance of the glass. However, if the content of BaO is too high, the density of the glass will increase and the devitrification resistance will be reduced. Therefore, the content of BaO is 5-20%, preferably 8-18%, more preferably 11-16%.

In some implementations, the ratio of the content of SiO₂ to the total content of CaO and BaO (CaO+BaO), i.e., SiO₂/(CaO+BaO), is controlled to be within a range of 0.05-1.5, which can increase the weather resistance of the glass and optimize the abrasion degree of the glass. Therefore, SiO₂/(CaO+BaO) is preferably 0.05-1.5, SiO₂/(CaO+BaO) is more preferably 0.1-1.0. Furthermore, SiO₂/(CaO+BaO) is controlled to be within a range of 0.2-0.85, which can also further increase the Young's modulus of the glass and optimize the thermal expansion coefficient of the glass. Therefore, SiO₂/(CaO+BaO) is further preferably 0.2-0.85, SiO₂/(CaO+BaO) is more further preferably 0.35-0.75.

In some implementations, the total content RO of alkaline-earth metal oxides MgO, CaO, SrO, and BaO is controlled to be within a range of 6-35%, and the glass is easier to obtain the desired optical constant, optimize the chemical stability of the glass, and prevent the devitrification resistance of the glass from reduction. Therefore, RO is preferably 6-35%, more preferably 10-25%, further preferably 11-20%.

ZnO can adjust the refractive index and dispersion of the glass, and reduce the high-temperature viscosity and transition temperature of the glass. If the content of ZnO is too high, the devitrification resistance of the glass will deteriorate. Therefore, the content of ZnO is 0-10%, preferably 1-8%, more preferably 2-7%.

In some implementations, the ratio of the total content of CaO and ZnO (CaO+ZnO) to the content of BaO, i.e., (CaO+ZnO)/BaO, is controlled to be within a range of 0.1-3.0, which can increase the light transmittance of the glass and meanwhile prevent the density of the glass from increasing. Therefore, (CaO+ZnO)/BaO is preferably 0.1-3.0, and (CaO+ZnO)/BaO is more preferably 0.2-2.0. Furthermore, (CaO+ZnO)/BaO is controlled to be within a range of 0.3-1.0, which can also further increase the bubble degree of the glass and prevent the Young's modulus of the glass from deterioration. Therefore, (CaO+ZnO)/BaO is further preferably 0.3-1.0, and (CaO+ZnO)/BaO is more further preferably 0.3-0.8.

In some implementations, the ratio of the total content of ZnO, Gd₂O₃, and Y₂O₃ (ZnO+Gd₂O₃+Y₂O₃) to the content of CaO, i.e., (ZnO+Gd₂O₃+Y₂O₃)/CaO is controlled to be below 5.0, which can reduce the thermal expansion coefficient of the glass and prevent the weather resistance from reduction. Thus, (ZnO+Gd₂O₃+Y₂O₃)/CaO is preferably below 5.0, and (ZnO+Gd₂O₃+Y₂O₃)/CaO is more preferably below 4.0. Furthermore, (ZnO+Gd₂O₃+Y₂O₃)/CaO is controlled to be within a range of 0.2-3.0, which can further optimize the bubble degree and hardness of the glass. Therefore, (ZnO+Gd₂O₃+Y₂O₃)/CaO is further preferably 0.2-3.0, and (ZnO+Gd₂O₃+Y₂O₃)/CaO is more further preferably 0.5-2.0.

TiO₂ can increase the refractive index and dispersion of the glass, and improve the devitrification resistance of the glass, but over-high content will greatly reduce the dispersion coefficient and devitrification tends to increase, or even significantly increase the staining degree of the glass. Therefore, the content of TiO₂ is confined to 5-20%, preferably 8-18%, more preferably 11-16%.

In some implementations, the ratio of the content of TiO₂ to the total content of La₂O₃ and ZnO (La₂O₃+ZnO), i.e., TiO₂/(La₂O₃+ZnO), is controlled to be within a range of 0.1-0.6, which can reduce the transition temperature of the glass and meanwhile prevent the light transmittance of the glass from reduction. Therefore, TiO₂/(La₂O₃+ZnO) is preferably 0.1-0.6, and TiO₂/(La₂O₃+ZnO) is more preferably 0.15-0.55. Furthermore, TiO₂/(La₂O₃+ZnO) is controlled to be within a range of 0.2-0.5, which can also further increase the Young's modulus of the glass and optimize the abrasion degree. Therefore, TiO₂/(La₂O₃+ZnO) is further preferably 0.2-0.5, and TiO₂/(La₂O₃+ZnO) is more further preferably 0.25-0.45.

In some implementations, the ratio of the content of TiO₂ to the content of BaO, i.e., TiO₂/BaO, is controlled to be within a range of 0.3-3.0, which can increase the Young's modulus of the glass and prevent the thermal expansion coefficient from increasing. Therefore, TiO₂/BaO is preferably 0.3-3.0, and TiO₂/BaO is more preferably 0.4-2.0. Furthermore, TiO₂/BaO is controlled to be within a range of 0.6-1.5, which can also further increase the hardness and chemical stability of the glass. Therefore, TiO₂/BaO is further preferably 0.6-1.5, and TiO₂/BaO is more further preferably 0.8-1.3.

Nb₂O₅ is a high-refractivity high-dispersion component, can increase the refractive index and devitrification resistance of the glass, and reduce the thermal expansion coefficient of the glass. If the content of Nb₂O₅ exceeds 12%, the thermal stability and weather resistance of the glass will be reduced and the light transmittance will be decreased. Therefore, the content of Nb₂O₅ in the present invention is 0-12%, preferably 1-10%, more preferably 2-7%.

In some implementations, the ratio of the content of BaO to the content of Nb₂O₅, i.e., BaO/Nb₂O₅, is controlled to be above 0.8, which can increase the light transmittance and chemical stability of the glass. Therefore, BaO/Nb₂O₅ is preferably above 0.8, and BaO/Nb₂O₅ is more preferably 1.0-20.0. Furthermore, BaO/Nb₂O₅ is controlled to be within a range of 1.5-10.0, which can further reduce the thermal expansion coefficient and transition temperature of the glass. Therefore, BaO/Nb₂O₅ is further preferably 1.5-10.0, and BaO/Nb₂O₅ is more further preferably 2.0-5.0.

In some implementations, the ratio of the content of La₂O₃ to the total content of ZnO and Nb₂O₅(ZnO+Nb₂O₅), i.e., La₂O₃/(ZnO+Nb₂O₅), is controlled to be within a range of 2.0-15.0, which can increase the bubble degree of the glass and reduce the transition temperature of the glass. Therefore, La₂O₃/(ZnO+Nb₂O₅) is preferably 2.0-15.0, and La₂O₃/(ZnO+Nb₂O₅) is more preferably 2.5-10.0. Furthermore, La₂O₃/(ZnO+Nb₂O₅) is controlled to be within a range of 3.0-8.0, which can also further optimize the density and abrasion degree of the glass. Therefore, La₂O₃/(ZnO+Nb₂O₅) is further preferably 3.0-8.0, and La₂O₃/(ZnO+Nb₂O₅) is more further preferably 3.5-6.0.

Ta₂O₅ has the effect of increasing the refractive index and enhancing the devitrification resistance of the glass. However, if the content of Ta₂O₅ is too high, the thermal stability of the glass will be decreased, the density will be increased, and the optical constant is difficult to be controlled within the desired range; on the other hand, compared with other ingredients, the price of Ta₂O₅ is very expensive, and from the perspective of practicality and cost, the usage amount of Ta₂O₅ should be minimized. Therefore, the content of Ta₂O₅ is confined to 0-5%, preferably 0-3%, more preferably 0-1%. In some implementations, it further preferably contains no Ta₂O₅.

Alkali metal oxide Rn₂O (Rn₂O is one or more of Li₂O, Na₂O, and K₂O) can reduce the transition temperature of the glass, adjust the optical constant and high-temperature viscosity of the glass, and improve the melting performance of the glass. However, when the content of Rn₂O is high, the devitrification resistance and chemical stability of the glass will be reduced and the refractive index will be reduced. Therefore, the content of Rn₂O is 0-8%, preferably 04%, more preferably 0-2%. In some implementations, it further preferably contains no Rn₂O.

WO₃ can increase the refractive index and mechanical strength of the glass. If the content of WO₃ exceeds 5%, the thermal stability of the glass will decrease, and the devitrification resistance will reduce. Therefore, the upper limit of the WO₃ content is 5%, preferably 3%, more preferably 1%. In some implementations, it further preferably contains no WO₃.

Al₂O₃ can improve the chemical stability of the glass, but when the content of Al₂O₃ exceeds 5%, the melting performance and light transmittance of the glass will deteriorate. Therefore, the content of Al₂O₃ is 0-5%, preferably 0-3%, more preferably 0-1%. In some implementations, it further preferably contains no Al₂O₃.

GeO₂ has the effect of increasing the refractive index and devitrification resistance of the glass, but if the content of GeO₂ is too high, the chemical stability of the glass will be decreased; on the other hand, compared with other ingredients, the price of GeO₂ is very expensive, and from the perspective of practicality and cost, the usage amount of GeO₂ should be minimized. Therefore, the content of GeO₂ in the present invention is confined to 0-5%, preferably 0-3%, more preferably 0-1%, it further preferably contains no GeO₂.

By comprising one or more components of 0-1% of Sb₂O₃, SnO, SnO₂, and CeO₂ as clarifying agent in the present invention, it can increase the clarifying effect of the glass and improve the bubble degree of the glass. The content of the clarifying agent is preferably 0-0.5%, and the content of clarifying agent is more preferably 0-0.2%. Due to the reasonable design of component type and content as well as excellent bubble degree of the optical glass provided by the present invention, it further preferably contains 0% clarifying agent in some implementations. When the content of Sb₂O₃ exceeds 1%, the glass has a tendency to clarify the performance degradation, and meanwhile, because of its strong oxidation, it promotes the corrosion of platinum or platinum alloy vessel for melting glass and the deterioration of the molding mould. Therefore, the content of Sb₂O₃ in the present invention is preferably 0-1%, more preferably 0-0.5%, further preferably 0-0.2%, and more further preferably 0%. SnO and SnO₂ can also be used as clarifying agents, but when the content of SnO and SnO₂ exceeds 1%, the glass coloring tendency will increase, or when the glass is reformed by heating, softening and die pressing, Sn will become the starting point for crystal nuclei generation, resulting in a tendency to produce devitrification. Therefore, the content of SnO₂ in the present invention is preferably 0-1%, more preferably 0-0.5%, further preferably 0-0.2%, more further preferably 0%; the content of SnO is preferably 0-1%, more preferably 0-0.5%, further preferably 0-0.2%, more further preferably 0%. The role and content proportion of CeO₂ are consistent with SnO₂, so the content of CeO₂ is preferably 0-1%, more preferably 0-0.5%, further preferably 0-0.2%, more further preferably 0%.

### <Unnecessary Components>

In the glass of the present invention, for the transition metal oxides such as V, Cr, Mn, Fe, Co, Ni, Cu, Ag and Mo, even if they are contained in small amounts in a single or compound form, the glass could be colored and absorb at a specific wavelength in the visible light region, thereby impairing the properties of the present invention in increasing the visible light transmittance, and therefore, in particular, for optical glass with requirement on wavelength transmittance in the visible region, it is preferably not actually included.

Th, Cd, Tl, Os, Be and Se oxides have been used in a controlled manner as a harmful chemical substance in recent years, which is necessary not only in the glass manufacturing process, but also in the processing procedure and disposal after the productization for environmental protection measures. Therefore, in the case of attaching importance to the influence on the environment, it is preferably not actually included except for the inevitable incorporation. As a result, the optical glass does not actually contain a substance that contaminates the environment. Therefore, the optical glass of the present invention can be manufactured, processed, and discarded even if a measure is not taken as a special environmental countermeasure.

In order to achieve environmental friendliness, the optical glass of the present invention preferably does not contain As₂O₃ and PbO.

The terms “not contained” and “0%” as used herein mean that the compound, molecule or element and the like are not intentionally added to the optical glass of the present invention as raw materials; however, as raw materials and/or equipment for the production of optical glass, there will be some impurities or components that are not intentionally added in small or trace amounts in the final optical glass, and this situation also falls within the protection scope of the present invention patent.

Hereinafter, the performance of the optical glass provided by the present invention will be described.

### <Refractive Index and Abbe Number>

The refractive index (n_{d}) and Abbe number (v_{d}) of the optical glass is tested as per the method specified in GB/T 7962.1-2010.

In some implementations, the lower limit of the refractive index (n_{d}) of the optical glass provided by the present invention is 1.87, preferably 1.88, more preferably 1.89.

In some implementations, the upper limit of the refractive index (n_{d}) of the optical glass provided by the present invention is 1.93, preferably 1.92, more preferably 1.91.

In some implementations, the lower limit of the Abbe number (v_{d}) of the optical glass provided by the present invention is 28, preferably 29, more preferably 30.

In some implementations, the upper limit of the Abbe number (v_{d}) of the optical glass provided by the present invention is 35, preferably 34, more preferably 33.

### <Thermal Expansion Coefficient>

The thermal expansion coefficient (α_{-30/70° C.}) of the optical glass is tested at −30~70° C. as per the method specified in GB/T 7962.16-2010.

In some implementations, the thermal expansion coefficient (α_{-30/70° C.}) of the optical glass provided by the present invention is below 95×10⁻⁷/K, preferably below 90×10⁻⁷/K, more preferably below 85×10⁻⁷/K, further preferably below 80×10⁻⁷/K.

### <Water Resistance Stability>

The water resistance stability (D_{W}) (powder method) of the optical glass is tested as per the method specified in GB/T 17129.

In some implementations, the water resistance stability (D_{W}) of the optical glass provided by the present invention is above Class 2, preferably Class 1.

### <Staining Degree>

The short-wave transmission spectrum characteristics of the glass provided by the present invention are represented by staining degree (λ₇₀ and λ₅). λ₇₀ refers to a wavelength corresponding to a glass transmittance of 70%. The measurement of λ₇₀ is carried out using a glass having a thickness of 10±0.1 mm with two opposing planes parallel to each other and optically polished, measuring the spectral transmittance in the wavelength region from 280 nm to 700 nm and a wavelength exhibiting 70% of the transmittance. The spectral transmittance or transmittance is an amount indicated by Iᵢₙ in the case where the light of an intensity Iᵢₙ is incident perpendicularly to the above surface of the glass, passes through the glass and passes an amount represented by Iₒᵤₜ/Iᵢₙ while emitting the light of an intensity Iₒᵤₜ from a plane, and includes the transmittance of the surface reflection loss on the above surface of the glass. The higher the refractive index of the glass is, the greater the surface reflection loss becomes. Therefore, in the glass with high refractive index, a small value of λ₇₀ means that the glass itself is colored very little and the light transmittance is high.

In some implementations, λ₇₀ of the optical glass provided by the present invention is below 420 nm, preferably below 415 nm, more preferably below 410 nm.

In some implementations, λ₅ of the optical glass provided by the present invention is below 380 nm, preferably below 375 nm, more preferably below 370 nm.

### <Weather Resistance>

The weather resistance (CR) test method of the optical glass is as follows: place the sample in a test chamber in a saturated water vapor environment with a relative humidity of 90%, and cycle alternately at 40-50° C. every 1 h for 15 cycles. The weather resistance is classified according to the turbidity change before and after the sample placement. The classification of weather resistance is shown in Table 1:

TABLE 1

| | Category | | | | | |
|---|---|---|---|---|---|---|
| | | | | 4 | | |
| | 1 | 2 | 3 | a | b | C |
| Turbidity | <0.3 | 0.3-1.0 | 1.0-2.0 | 2.0-4.0 | 4.0-6.0 | ≥6.0 |
| increase | | | | | | |
| ΔH (%) | | | | | | |

In some implementations, the weather resistance (CR) of the optical glass provided by the present invention is above Class 2, preferably Class 1.

### <Knoop Hardness>

The Knoop hardness (H_{K}) of the optical glass is tested according to the method specified in GB/T7962.18-2010.

In some implementations, the Knoop hardness (H_{K}) of the optical glass provided by the present invention is above 580×10⁷ Pa, preferably above 590×10⁷ Pa, more preferably above 600×10⁷ Pa, further preferably above 605×10⁷ Pa.

### <Young's Modulus>

The Young's modulus (E) is tested by ultrasonic wave for P-wave velocity and S-wave velocity, and then calculated according to the following formula.

$$E = \frac{4 {G}^{2} - 3 {GV}_{T}^{2} ρ}{G - {V}_{T}^{2} ρ}$$

$$G = {Vs}^{2} ρ$$

Wherein: E refers to Young's modulus, Pa;
G refers to shear modulus, Pa;
V_{T} refers to S-wave velocity, m/s;
V_{S} refers to P-wave velocity, m/s;
ρ refers to glass density, g/cm³.

In some implementations, Young's modulus (E) of the optical glass provided by the present invention is above 10000×10⁷ Pa, preferably above 10500×10⁷ Pa, more preferably above 11000×10⁷ Pa.

### <Bubble Degree>

The bubble degree of the optical glass is tested as per the method specified in GB/T7962.8-2010.

In some implementations, the bubble degree of the optical glass provided by the present invention is above Grade A, preferably above Grade A₀, more preferably Grade A₀₀.

### <Density>

The density (ρ) of the optical glass is tested as per the method specified in GB/T7962.20-2010.

In some implementations, the density (ρ) of the optical glass provided by the present invention is below 4.90 g/cm³, preferably below 4.80 g/cm³, more preferably below 4.70 g/cm³, further preferably below 4.60 g/cm³.

### <Abrasion Degree>

Abrasion degree (F_{A}) of optical glass refers to the data obtained by the ratio of the abrasion quantity of sample to the abrasion quantity (volume) of the standard sample (H-K9 optical glass) multiplying by 100 with the formula below under exactly the same conditions:

$${F}_{A} = V / {V}_{0} \times 100 = ( W / ρ ) / ( {W}_{0} / {ρ}_{0} ) \times 100$$

Wherein: V—volume abrasion quantity of the tested sample;
V₀—volume abrasion quantity of the standard sample;
W—mass abrasion quantity of the tested sample;
W₀—mass abrasion quantity of the standard sample;
ρ—density of the tested sample;
ρ₀—density of the standard sample.

In some implementations, the lower limit of the abrasion degree (F_{A}) of the optical glass provided by the present invention is 125, preferably 130, more preferably 135.

In some implementations, the upper limit of the abrasion degree (F_{A}) of the optical glass provided by the present invention is 165, preferably 160, more preferably 155.

### <Transition Temperature>

The transition temperature (T_{g}) of the optical glass is tested as per the method specified in GB/T7962.16-2010.

In some implementations, the transition temperature (T_{g}) of the optical glass provided by the present invention is below 700° C., preferably below 690° C., more preferably below 680° C., further preferably below 678° C.

### [Manufacturing Method of Optical Glass]

The manufacturing method of the optical glass provided by the present invention is as follows: the glass of the present invention is made of conventional raw materials and processes, including but not limited to using oxide, hydroxide, compound salt (e.g., carbonate, nitrate, and sulfate), and boric acid as raw materials, mixing the ingredients according to the conventional method, and then feeding the mixed furnace burden into a 1200-1500° C. smelting furnace (e.g., platinum or platinum alloy crucible) for melting, obtaining homogeneous molten glass without bubbles and undissolved substances after clarification and homogenization, shaping the molten glass in a mould, and performing annealing. Those skilled in the art can appropriately select raw materials, process methods and process parameters according to actual needs.

### [Glass Preform and Optical Element]

The glass preform can be made from the optical glass formed by, for example, direct drop forming, grinding or thermoforming, and other compression molding means. That is to say, the precision glass preform can be made by direct precision drop molding of molten optical glass, or glass preform can be made by grinding and other machining methods, or the glass preform can be made by making a preform for compression molding with the optical glass, re-thermoforming this preform, and then grinding the preform. It should be noted that the means for preparing glass preform is not limited to the above means.

As mentioned above, the optical glass of the present invention is useful for various optical elements and optical designs, wherein the particularly preferred method is to form a preform by the optical glass of the present invention, and use this preform for re-thermoforming, precision stamping and the like to make optical elements such as lens and prism.

The glass preform and the optical element of the present invention are both formed by the optical glass of the present invention described above. The glass preform of the present invention has excellent characteristics of the optical glass; the optical element of the present invention has excellent characteristics of the optical glass, and can provide such optical elements as a variety of lenses and prisms having a high optical value.

Examples of the lens include various lenses with spherical or aspheric surfaces, such as concave meniscus lens, convex meniscus lens, biconvex lens, biconcave lens, planoconvex lens and planoconcave lens.

### [Optical Instrument]

The optical element formed by the optical glass of the present invention can make optical instruments such as photographic equipment, camera equipment, projector equipment, display equipment, on-board equipment and monitoring equipment.

### EMBODIMENT

### <Optical Glass Embodiment>

The following non-limiting embodiments are provided in order to further clearly explain and illustrate the technical solution of the present invention.

This embodiment obtains the optical glass with composition as shown in Table 2-Table 4 by the manufacturing method of the above-mentioned optical glass. In addition, the characteristics of each glass are measured by the test method described in the present invention, and the measurement results are shown in Tables 2 to 4.

TABLE 2

| | Embodiment (wt %) | | | | | | | |
|---|---|---|---|---|---|---|---|---|
| | 1# | 2# | 3# | 4# | 5# | 6# | 7# | 8# |
| SiO₂ | 2.37 | 4.16 | 10.42 | 9.33 | 13.2 | 6.13 | 3.35 | 11.25 |
| B₂O₃ | 18.12 | 16.34 | 10.54 | 6.7 | 8.56 | 10.45 | 11.23 | 7.74 |
| La₂O₃ | 27.34 | 48.02 | 34.47 | 45.85 | 27.23 | 32 | 46.94 | 31.47 |
| Y₂O₃ | 0 | 1.2 | 0 | 2.5 | 0 | 0.5 | 0 | 3.2 |
| Gd₂O₃ | 0.4 | 0 | 0 | 0 | 0 | 1.2 | 0 | 0 |
| Yb₂O₃ | 0 | 0 | 0 | 0 | 0 | 0 | 0 | 0 |
| ZrO₂ | 10.72 | 2.24 | 1.85 | 4.35 | 9.23 | 8.18 | 3.52 | 4.17 |
| Nb₂O₅ | 2.8 | 5.23 | 3.14 | 3.87 | 1.25 | 3.42 | 2.85 | 9.3 |
| TiO₂ | 10.23 | 6.72 | 8.45 | 12.2 | 18.25 | 11.35 | 9.26 | 13.2 |
| Ta₂O₅ | 0 | 0 | 1 | 0.5 | 0 | 0 | 0 | 0 |
| MgO | 0 | 0 | 0 | 0 | 0 | 0 | 0 | 0 |
| CaO | 9.2 | 4.23 | 11.4 | 1.35 | 2.26 | 4.5 | 3.6 | 5.2 |
| SrO | 0 | 0 | 0 | 0 | 0 | 0 | 0 | 0 |
| BaO | 17.32 | 7.66 | 18.13 | 9.45 | 10.6 | 15.38 | 13.7 | 8.85 |
| Li₂O | 0 | 0 | 0 | 0 | 1.1 | 0 | 0.4 | 0 |
| Na₂O | 0 | 2 | 0 | 0.6 | 0 | 0 | 0 | 0 |
| K₂O | 0 | 0 | 0 | 0 | 0 | 0.55 | 0 | 0 |
| WO₃ | 0 | 0 | 0.5 | 0 | 0 | 0 | 0 | 0 |
| ZnO | 1.4 | 2.2 | 0 | 3.3 | 8.12 | 6.24 | 4.15 | 5.62 |
| Al₂O₃ | 0 | 0 | 0 | 0 | 0 | 0 | 1 | 0 |
| GeO₂ | 0 | 0 | 0 | 0 | 0 | 0 | 0 | 0 |
| Sb₂O₃ | 0.1 | 0 | 0.1 | 0 | 0 | 0 | 0 | 0 |
| SnO | 0 | 0 | 0 | 0 | 0 | 0 | 0 | 0 |
| SnO₂ | 0 | 0 | 0 | 0 | 0.2 | 0.1 | 0 | 0 |
| CeO₂ | 0 | 0 | 0 | 0 | 0 | 0 | 0 | 0 |
| Total | 100 | 100 | 100 | 100 | 100 | 100 | 100 | 100 |
| RO | 26.52 | 11.89 | 29.53 | 10.8 | 12.86 | 19.88 | 17.3 | 14.05 |
| CaO/(SiO₂ + ZrO₂) | 0.703 | 0.661 | 0.929 | 0.099 | 0.101 | 0.314 | 0.524 | 0.337 |
| TiO₂/BaO | 0.591 | 0.877 | 0.466 | 1.291 | 1.722 | 0.738 | 0.676 | 1.492 |
| TiO₂/(La₂O₃ + ZnO) | 0.356 | 0.134 | 0.245 | 0.248 | 0.516 | 0.297 | 0.181 | 0.356 |
| SiO₂/(CaO + BaO) | 0.089 | 0.35 | 0.353 | 0.864 | 1.026 | 0.308 | 0.194 | 0.801 |
| BaO/Nb₂O₅ | 6.186 | 1.465 | 5.774 | 2.442 | 8.48 | 4.497 | 4.807 | 0.952 |
| (CaO + ZnO)/BaO | 0.612 | 0.839 | 0.629 | 0.492 | 0.979 | 0.698 | 0.567 | 1.223 |
| La₂O₃/(ZnO + Nb₂O₅) | 6.51 | 6.463 | 10.978 | 6.395 | 2.906 | 3.313 | 6.706 | 2.109 |
| (ZnO + Gd₂O₃ + | 0.196 | 0.804 | 0 | 4.296 | 3.593 | 1.764 | 1.153 | 1.696 |
| Y₂O₃)/CaO | | | | | | | | |
| n_{d} | 1.8753 | 1.9245 | 1.8923 | 1.9263 | 1.8845 | 1.8876 | 1.9158 | 1.8905 |
| v_{d} | 32.38 | 34.26 | 34.55 | 31.43 | 29.15 | 30.32 | 29.57 | 28.75 |
| D_{W} | Class 1 | Class 1 | Class 1 | Class 1 | Class 1 | Class 1 | Class 1 | Class 1 |
| CR | Class 1 | Class 1 | Class 1 | Class 1 | Class 1 | Class 1 | Class 1 | Class 1 |
| H_{K}(×10⁷Pa) | 602 | 611 | 604 | 606 | 605 | 608 | 607 | 611 |
| F_{A} | 155 | 158 | 157 | 137 | 156 | 148 | 142 | 134 |
| E(×10⁷Pa) | 11231 | 11434 | 11502 | 11367 | 11323 | 11583 | 11543 | 11528 |
| ρ(g/cm³) | 4.58 | 4.57 | 4.62 | 4.57 | 4.56 | 4.54 | 4.52 | 4.63 |
| λ₇₀(nm) | 402 | 407 | 408 | 405 | 410 | 402 | 403 | 411 |
| λ₅(nm) | 363 | 368 | 368 | 364 | 370 | 360 | 361 | 370 |
| Bubble degree (level) | A₀₀ | A₀₀ | A₀ | A₀₀ | A₀₀ | A₀₀ | A₀₀ | A₀ |
| α_{-30/70° C.}(×10⁻⁷/K) | 82 | 78 | 83 | 79 | 83 | 74 | 78 | 77 |
| T_{g}(° C.) | 678 | 680 | 682 | 671 | 670 | 672 | 679 | 681 |

TABLE 3

| | Embodiment (wt %) | | | | | | | |
|---|---|---|---|---|---|---|---|---|
| | 9# | 10# | 11# | 12# | 13# | 14# | 15# | 16# |
| SiO₂ | 10.46 | 8.3 | 7.12 | 6.56 | 9.04 | 7.28 | 6.44 | 5.82 |
| B₂O₃ | 5.26 | 12.2 | 11.75 | 10.64 | 14.32 | 15.8 | 9.45 | 11.23 |
| La₂O₃ | 27.88 | 39.03 | 31.55 | 39.54 | 26.38 | 27.65 | 41.4 | 41.95 |
| Y₂O₃ | 0 | 0 | 1.3 | 0 | 0 | 0 | 0 | 0 |
| Gd₂O₃ | 2.5 | 0 | 0 | 0 | 0 | 0 | 0 | 0 |
| Yb₂O₃ | 0 | 0 | 0 | 0 | 0 | 0 | 0 | 0 |
| ZrO₂ | 7.02 | 5.65 | 6.32 | 4.48 | 7.22 | 6.34 | 5.25 | 4.82 |
| Nb₂O₅ | 8.25 | 4.6 | 5.25 | 6.18 | 3.27 | 7.2 | 5.33 | 4.62 |
| TiO₂ | 15.34 | 14.4 | 16.2 | 11.43 | 10.28 | 14.5 | 12.53 | 13.7 |
| Ta₂O₅ | 0 | 0 | 0 | 0 | 0 | 0 | 0 | 0 |
| MgO | 0 | 0 | 0 | 1.2 | 0 | 0 | 0 | 0 |
| CaO | 7.33 | 4.32 | 3.75 | 2.64 | 8.13 | 5.16 | 3.37 | 3.26 |
| SrO | 0 | 0 | 0 | 0 | 0 | 0 | 0 | 0 |
| BaO | 14.26 | 11.5 | 12.53 | 14.62 | 16.6 | 12.25 | 13.06 | 11.77 |
| Li₂O | 0 | 0 | 0 | 0 | 0 | 0 | 0 | 0 |
| Na₂O | 0 | 0 | 0 | 0 | 0 | 0 | 0 | 0 |
| K₂O | 0 | 0 | 0 | 0 | 0 | 0 | 0 | 0 |
| WO₃ | 1 | 0 | 0 | 0 | 0 | 0 | 0 | 0 |
| ZnO | 0.7 | 0 | 3.63 | 2.71 | 4.66 | 3.82 | 3.17 | 2.63 |
| Al₂O₃ | 0 | 0 | 0.5 | 0 | 0 | 0 | 0 | 0 |
| GeO₂ | 0 | 0 | 0 | 0 | 0 | 0 | 0 | 0 |
| Sb₂O₃ | 0 | 0 | 0 | 0 | 0 | 0 | 0 | 0 |
| SnO | 0 | 0 | 0.1 | 0 | 0 | 0 | 0 | 0 |
| SnO₂ | 0 | 0 | 0 | 0 | 0.1 | 0 | 0 | 0.2 |
| CeO₂ | 0 | 0 | 0 | 0 | 0 | 0 | 0 | 0 |
| Total | 100 | 100 | 100 | 100 | 100 | 100 | 100 | 100 |
| RO | 21.59 | 15.82 | 16.28 | 18.46 | 24.73 | 17.41 | 16.43 | 15.03 |
| CaO/(SiO₂ + ZrO₂) | 0.419 | 0.31 | 0.279 | 0.239 | 0.5 | 0.379 | 0.288 | 0.306 |
| TiO₂/BaO | 1.076 | 1.252 | 1.293 | 0.782 | 0.619 | 1.184 | 0.959 | 1.164 |
| TiO₂/(La₂O₃ + ZnO) | 0.537 | 0.369 | 0.46 | 0.271 | 0.331 | 0.461 | 0.281 | 0.307 |
| SiO₂/(CaO + BaO) | 0.484 | 0.525 | 0.437 | 0.38 | 0.366 | 0.418 | 0.392 | 0.387 |
| BaO/Nb₂O₅ | 1.728 | 2.5 | 2.387 | 2.366 | 5.076 | 1.701 | 2.45 | 2.548 |
| (CaO + ZnO)/BaO | 0.563 | 0.376 | 0.589 | 0.366 | 0.77 | 0.733 | 0.501 | 0.5 |
| La₂O₃/(ZnO + Nb₂O₅) | 3.115 | 8.485 | 3.553 | 4.448 | 3.327 | 2.509 | 4.871 | 5.786 |
| (ZnO + Gd₂O₃ + | 0.437 | 0 | 1.315 | 1.027 | 0.573 | 0.74 | 0.941 | 0.807 |
| Y₂O₃)/CaO | | | | | | | | |
| n_{d} | 1.8914 | 1.9013 | 1.9042 | 1.9105 | 1.9033 | 1.9071 | 1.9084 | 1.8958 |
| v_{d} | 28.36 | 29.82 | 29.04 | 31.37 | 33.26 | 30.85 | 31.22 | 31.78 |
| D_{W} | Class 1 | Class 1 | Class 1 | Class 1 | Class 1 | Class 1 | Class 1 | Class 1 |
| CR | Class 1 | Class 1 | Class 1 | Class 1 | Class 1 | Class 1 | Class 1 | Class 1 |
| H_{K} (×10⁷Pa) | 608 | 610 | 612 | 615 | 613 | 615 | 611 | 614 |
| F_{A} | 135 | 137 | 143 | 145 | 142 | 140 | 145 | 147 |
| E (×10⁷Pa) | 11692 | 11794 | 11831 | 11658 | 11763 | 11793 | 11832 | 11796 |
| ρ (g/cm³) | 4.52 | 4.58 | 4.56 | 4.55 | 4.52 | 4.60 | 4.54 | 4.52 |
| λ_{7 0}(nm) | 402 | 401 | 400 | 398 | 396 | 395 | 400 | 400 |
| λ₅ (nm) | 362 | 360 | 358 | 357 | 355 | 355 | 361 | 360 |
| Bubble degree (level) | A₀₀ | A₀ | A₀₀ | A₀₀ | A₀₀ | A₀ | A₀₀ | A₀₀ |
| α_{-30/70° C.}(×10⁻⁷/K) | 78 | 80 | 73 | 75 | 76 | 77 | 75 | 73 |
| T_{g}(° C.) | 683 | 680 | 674 | 672 | 673 | 684 | 673 | 670 |

TABLE 4

| | Embodiment (wt %) | | | | | | | |
|---|---|---|---|---|---|---|---|---|
| | 17# | 18# | 19# | 20# | 21# | 22# | 23# | 24# |
| SiO₂ | 12.2 | 7.32 | 8.24 | 8.18 | 9.27 | 6.54 | 7.55 | 8.62 |
| B₂O₃ | 13.65 | 14.02 | 10.23 | 11.73 | 12.64 | 12.32 | 11.72 | 13.5 |
| La₂O₃ | 32.88 | 36.84 | 38.07 | 34.14 | 35.54 | 36.45 | 39.65 | 37.24 |
| Y₂O₃ | 0 | 0 | 0 | 0 | 0 | 0 | 0 | 0 |
| Gd₂O₃ | 0 | 0 | 0 | 0 | 0 | 0 | 0 | 0 |
| Yb₂O₃ | 0 | 0 | 0 | 0 | 0 | 0 | 0 | 0 |
| ZrO₂ | 5.12 | 4.83 | 6.34 | 5.72 | 4.91 | 6.72 | 5.17 | 6.23 |
| Nb₂O₅ | 3.5 | 4.21 | 5.05 | 6.24 | 5.12 | 4.53 | 3.7 | 2.88 |
| TiO₂ | 11.93 | 12.27 | 13.06 | 14.58 | 13.64 | 12.9 | 12.56 | 13.45 |
| Ta₂O₅ | 0 | 0 | 0 | 0 | 0 | 0 | 0 | 0 |
| MgO | 0 | 0 | 0 | 0 | 0 | 0 | 0 | 0 |
| CaO | 4.03 | 2.74 | 2.88 | 3.42 | 3.5 | 4.24 | 3.18 | 2.44 |
| SrO | 0 | 0 | 0 | 0 | 0 | 0 | 0 | 0 |
| BaO | 14.24 | 13.74 | 12.56 | 11.84 | 12.75 | 13.82 | 12.72 | 12.5 |
| Li₂O | 0 | 0 | 0 | 0 | 0 | 0 | 0 | 0 |
| Na₂O | 0 | 0 | 0 | 0 | 0 | 0 | 0 | 0 |
| K₂O | 0 | 0 | 0 | 0 | 0 | 0 | 0 | 0 |
| WO₃ | 0 | 0 | 0 | 0 | 0 | 0 | 0 | 0 |
| ZnO | 2.45 | 4.03 | 3.47 | 4.15 | 2.63 | 2.48 | 3.75 | 3.14 |
| Al₂O₃ | 0 | 0 | 0 | 0 | 0 | 0 | 0 | 0 |
| GeO₂ | 0 | 0 | 0 | 0 | 0 | 0 | 0 | 0 |
| Sb₂O₃ | 0 | 0 | 0 | 0 | 0 | 0 | 0 | 0 |
| SnO | 0 | 0 | 0.1 | 0 | 0 | 0 | 0 | 0 |
| SnO₂ | 0 | 0 | 0 | 0 | 0 | 0 | 0 | 0 |
| CeO₂ | 0 | 0 | 0 | 0 | 0 | 0 | 0 | 0 |
| Total | 100 | 100 | 100 | 100 | 100 | 100 | 100 | 100 |
| RO | 18.27 | 16.48 | 15.44 | 15.26 | 16.25 | 18.06 | 15.9 | 14.94 |
| CaO/(SiO₂ + ZrO₂) | 0.233 | 0.226 | 0.198 | 0.246 | 0.247 | 0.32 | 0.25 | 0.164 |
| TiO₂/BaO | 0.838 | 0.893 | 1.04 | 1.231 | 1.07 | 0.933 | 0.987 | 1.076 |
| TiO₂/(La₂O₃ + ZnO) | 0.338 | 0.3 | 0.314 | 0.381 | 0.357 | 0.331 | 0.289 | 0.333 |
| SiO₂/(CaO + BaO) | 0.668 | 0.444 | 0.534 | 0.536 | 0.57 | 0.362 | 0.475 | 0.577 |
| BaO/Nb₂O₅ | 4.069 | 3.264 | 2.487 | 1.897 | 2.49 | 3.051 | 3.438 | 4.34 |
| (CaO + ZnO)/BaO | 0.455 | 0.493 | 0.506 | 0.639 | 0.481 | 0.486 | 0.545 | 0.446 |
| La₂O₃/(ZnO + Nb₂O₅) | 5.526 | 4.471 | 4.468 | 3.286 | 4.586 | 5.2 | 5.322 | 6.186 |
| (ZnO + Gd₂O₃ + | 0.608 | 1.471 | 1.205 | 1.213 | 0.751 | 0.585 | 1.179 | 1.287 |
| Y₂O₃)/CaO | | | | | | | | |
| n_{d} | 1.8984 | 1.9072 | 1.9055 | 1.8967 | 1.8984 | 1.9022 | 1.9043 | 1.9038 |
| v_{d} | 32.05 | 31.41 | 31.38 | 32.12 | 31.64 | 31.55 | 31.42 | 30.95 |
| D_{W} | Class 1 | Class 1 | Class 1 | Class 1 | Class 1 | Class 1 | Class 1 | Class 1 |
| CR | Class 1 | Class 1 | Class 1 | Class 1 | Class 1 | Class 1 | Class 1 | Class 1 |
| H_{K} (×10⁷Pa) | 612 | 616 | 614 | 612 | 613 | 612 | 615 | 614 |
| F_{A} | 144 | 148 | 150 | 144 | 146 | 143 | 147 | 148 |
| E (×10⁷Pa) | 11832 | 11814 | 11790 | 11688 | 11725 | 11884 | 11852 | 11808 |
| ρ (g/cm³) | 4.53 | 4.51 | 4.55 | 4.53 | 4.52 | 4.50 | 4.55 | 4.51 |
| λ₇₀ (nm) | 402 | 398 | 399 | 401 | 403 | 397 | 398 | 400 |
| λ₅ (nm) | 361 | 357 | 360 | 360 | 362 | 358 | 358 | 360 |
| Bubble degree (level) | A₀₀ | A₀₀ | A₀₀ | A₀₀ | A₀₀ | A₀₀ | A₀₀ | A₀₀ |
| α_{-30/70° C.}(×10⁻⁷/K) | 71 | 72 | 70 | 76 | 73 | 74 | 72 | 72 |
| T_{g}(° C.) | 672 | 67 | 668 | 678 | 672 | 674 | 672 | 670 |

### <Glass Preform Embodiment>

The glass obtained by Embodiments 1-24 # of the optical glass is made into a variety of lenses and prisms and other preforms such as concave meniscus lens, convex meniscus lens, biconvex lens, biconcave lens, planoconvex lens, and planoconcave lens by means of, for example, grinding, or re-thermoforming, precision stamping and other compression molding methods.

### <Optical Element Embodiment>

The preforms obtained in the above-mentioned glass preform embodiment are annealed for fine-tuning of refractive index while reducing the stress inside the glass, so that the optical characteristics such as the refractive index are brought to the desired values.

Then, each of the preforms is ground and polished, and a variety of lenses and prisms such as concave meniscus lens, convex meniscus lens, biconvex lens, biconcave lens, planoconvex lens, and planoconcave lens are prepared. An anti-reflection film may be coated on the surface of the obtained optical element.

### <Embodiments of Optical Instrument>

Through optical design and the use of one or more optical elements to form optical component or optical assembly, the optical element prepared by the above-mentioned optical element embodiment can be used, for example, in imaging device, sensor, microscope, medical technology, digital projection, communication, optical communication technology/information transmission, optics/lighting in the automobile field, photolithography, excimer laser, wafer, computer chip, and integrated circuit and electronic device including such circuit and chip.

What is claimed is:

1. An optical glass, wherein components thereof are represented by weight percentage, comprising: 1-15% of SiO₂; 5-20% of B₂O₃; 25-50% of La₂O₃; 1-12% of ZrO₂; 5-20% of TiO₂; 10-35% of RO, and the RO is total content of MgO, CaO, SrO, and BaO.

2. The optical glass according to claim 1, wherein components thereof are represented by weight percentage, further comprising: 0-8% of Y₂O₃; and/or 0-8% of Gd₂O₃; and/or 0-5% of Yb₂O₃; and/or 0-12% of Nb₂O₅; and/or 0-10% of ZnO; and/or 0-8% of Rn₂O; and/or 0-5% of GeO₂; and/or 0-5% of WO₃; and/or 0-5% of Ta₂O₅; and/or 0-5% of Al₂O₃; and/or 0-1% of clarifying agent, the Rn₂O is one or more of Li₂O, Na₂O, and K₂O, and the clarifying agent is one or more of Sb₂O₃, SnO, SnO₂, and CeO₂.

3. The optical glass according to claim 1, wherein components thereof are represented by weight percentage, and one or more of the following 8 conditions are satisfied:
1) CaO/(SiO₂+ZrO₂) is 0.02-1.0;
2) TiO₂/BaO is 0.3-3.0;
3) TiO₂/(La₂O₃+ZnO) is 0.1-0.6;
4) SiO₂/(CaO+BaO) is 0.05-1.5;
5) BaO/Nb₂O₅ is above 0.8;
6) (CaO+ZnO)/BaO is 0.1-3.0;
7) La₂O₃/(ZnO+Nb₂O₅) is 2.0-15.0;
8) (ZnO+Gd₂O₃+Y₂O₃)/CaO is below 5.0.

4. The optical glass according to claim 1, wherein components thereof are represented by weight percentage, and one or more of the following 8 conditions are satisfied:
1) CaO/(SiO₂+ZrO₂) is 0.05-0.8;
2) TiO₂/BaO is 0.4-2.0;
3) TiO₂/(La₂O₃+ZnO) is 0.15-0.55;
4) SiO₂/(CaO+BaO) is 0.1-1.0;
5) BaO/Nb₂O₅ is 1.0-20.0;
6) (CaO+ZnO)/BaO is 0.2-2.0;
7) La₂O₃/(ZnO+Nb₂O₅) is 2.5-10.0;
8) (ZnO+Gd₂O₃+Y₂O₃)/CaO is below 4.0.

5. The optical glass according to claim 1, wherein components thereof are represented by weight percentage, and one or more of the following 8 conditions are satisfied:
1) CaO/(SiO₂+ZrO₂) is 0.1-0.6;
2) TiO₂/BaO is 0.6-1.5;
3) TiO₂/(La₂O₃+ZnO) is 0.2-0.5;
4) SiO₂/(CaO+BaO) is 0.2-0.85;
5) BaO/Nb₂O₅ is 1.5-10.0;
6) (CaO+ZnO)/BaO is 0.3-1.0;
7) La₂O₃/(ZnO+Nb₂O₅) is 3.0-8.0;
8) (ZnO+Gd₂O₃+Y₂O₃)/CaO is 0.2-3.0.

6. The optical glass according to claim 1, wherein components thereof are represented by weight percentage, and one or more of the following 8 conditions are satisfied:
1) CaO/(SiO₂+ZrO₂) is 0.1-0.5;
2) TiO₂/BaO is 0.8-1.3;
3) TiO₂/(La₂O₃+ZnO) is 0.25-0.45;
4) SiO₂/(CaO+BaO) is 0.35-0.75;
5) BaO/Nb₂O₅ is 2.0-5.0;
6) (CaO+ZnO)/BaO is 0.3-0.8;
7) La₂O₃/(ZnO+Nb₂O₅) is 3.5-6.0;
8) (ZnO+Gd₂O₃+Y₂O₃)/CaO is 0.5-2.0.

7. The optical glass according to claim 1, wherein components thereof are represented by weight percentage, in which: SiO₂ is 3-12%; and/or B₂O₃ is 8-17%; and/or La₂O₃ is 31-45%; and/or ZrO₂ is 2-10%; and/or TiO₂ is 8-18%; and/or RO is 10-25%; and/or Y₂O₃ is 0-4%; and/or Gd₂O₃ is 0-4%; and/or Yb₂O₃ is 0-3%; and/or Nb₂O₅ is 1-10%; and/or ZnO is 1-8%; and/or Rn₂O is 0-4%; and/or GeO₂ is 0-3%; and/or WO₃ is 0-3%; and/or Ta₂O₅ is 0-3%; and/or Al₂O₃ is 0-3%; and/or clarifying agent is 0-0.5%, the RO is total content of MgO, CaO, SrO, and BaO, Rn₂O is one or more of Li₂O, Na₂O, and K₂O, and the clarifying agent is one or more of Sb₂O₃, SnO, SnO₂, and CeO₂.

8. The optical glass according to claim 1, wherein components thereof are represented by weight percentage, in which: SiO₂ is 5-10%; and/or B₂O₃ is 10-15%; and/or La₂O₃ is 34-40%; and/or ZrO₂ is 3-8%; and/or TiO₂ is 11-16%; and/or RO is 11-20%; and/or Y₂O₃ is 0-2%; and/or Gd₂O₃ is 0-2%; and/or Yb₂O₃ is 0-1%; and/or Nb₂O₅ is 2-7%; and/or ZnO is 2-7%; and/or Rn₂O is 0-2%; and/or GeO₂ is 0-1%; and/or WO₃ is 0-1%, and/or Ta₂O₅ is 0-1%; and/or Al₂O₃ is 0-1%; and/or clarifying agent is 0-0.2%, the RO is total content of MgO, CaO, SrO, and BaO, Rn₂O is one or more of Li₂O, Na₂O, and K₂O, and the clarifying agent is one or more of Sb₂O₃, SnO, SnO₂, and CeO₂.

9. The optical glass according to claim 1, wherein components thereof are represented by weight percentage, in which: BaO is 5-20%; and/or SrO is 0-10%; and/or CaO is 0-12%; and/or MgO is 0-10%.

10. The optical glass according to claim 1, wherein components thereof are represented by weight percentage, in which: BaO is 11-16%; and/or SrO is 0-2%; and/or CaO is 2-8%; and/or MgO is 0-2%.

11. The optical glass according to claim 1, wherein components thereof do not contain WO₃; and/or do not contain Ta₂O₅; and/or do not contain Rn₂O; and/or do not contain Al₂O₃; and/or do not contain GeO₂; and/or do not contain Y₂O₃; and/or do not contain Gd₂O₃; and/or do not contain SrO; and/or do not contain MgO; and/or do not contain Yb₂O₃, and the Rn₂O is one or more of Li₂, Na₂O, and K₂0.

12. The optical glass according to claim 1, wherein a refractive index n_{d} of the optical glass is 1.87-1.93, and an Abbe number v_{d} is 28-35.

13. The optical glass according to claim 1, wherein the refractive index n_{d} of the optical glass is 1.89-1.91, and the Abbe number v_{d} is 30-33.

14. The optical glass according to claim 1, wherein a thermal expansion coefficient α_{-30/70° C.} of the optical glass is below 95×10⁻⁷/K; and/or water resistance stability D_{W} is above Class 2; and/or λ₇₀ is below 420 nm; and/or λ₅ is below 380 nm; and/or weather resistance CR is above Class 2; and/or Knoop hardness H_{K} is above 580×10⁷ Pa; and/or Young's modulus E is above 10000×10⁷ Pa; and/or bubble degree is above Grade A; and/or density ρ is below 4.90 g/cm³; and/or abrasion degree f_{A} is 125-165; and/or transition temperature T_{g} is below 700° C.

15. The optical glass according to any of claim 1, wherein the thermal expansion coefficient α_{-30/70° C.} of the optical glass is below 80×10⁻⁷/K; and/or water resistance stability D_{W} is Class 1; and/or λ₇₀ is below 410 nm; and/or λ₅ is below 370 nm; and/or weather resistance CR is Class 1; and/or Knoop hardness H_{K} is above 605×10⁷ Pa; and/or Young's modulus E is above 11000×10⁷ Pa; and/or bubble degree is Grade A₀₀; and/or density ρ is below 4.60 g/cm³; and/or abrasion degree f_{A} is 135-155; and/or transition temperature T_{g} is below 678° C.

16. An optical element, made of the optical glass according to any of claim 1.

17. An optical instrument, comprising the optical glass according to any of claim 1.
